(19) United States
(12) Patent Application Publication
(10) Pub. No.: US 2025/0278648 A1
(43) Pub. Date: Sep. 4, 2025

(54) RECOMMENDATION DATA PROCESSING METHOD, RECOMMENDATION METHOD, AND ELECTRONIC DEVICE AND STORAGE MEDIUM

(71) Applicant: Hangzhou Alibaba International Internet Industry Co., Ltd., Hangzhou (CN)

(72) Inventors: Sheng XU, Hangzhou (CN); Fankun ZHOU, Hangzhou (CN)

(21) Appl. No.: 19/214,008

(22) Filed: May 20, 2025

Related U.S. Application Data
(63) Continuation of application No. PCT/CN2023/130863, filed on Nov. 9, 2023.

(30) Foreign Application Priority Data
Nov. 22, 2022 (CN) 202211469151.2

(51) Int. Cl. G06N 5/04; G06N 5/02; G06Q 30/0601

(52) U.S. Cl. CPC G06N 5/04; G06N 5/02; G06Q 30/0631

(57) ABSTRACT

This application provides a method for processing recommendation data, a recommendation method, an electronic device, and a storage medium. The recommendation data processing method comprises: obtaining first definition information regarding a target scenario, wherein the first definition information is generated based on a knowledge graph related to the target scenario, the target scenario being a scenario involving a plurality of categories of objects, and the first definition information comprises the plurality of categories of objects; obtaining second definition information about the target scenario based on the first definition information, wherein the second definition information comprises a combination of target categories including at least one target category from the plurality of categories; generating recommendation data for an object corresponding to the combination of target categories based on the second definition information.

### CROSS-REFERENCE TO RELATED APPLICATION

This application is a Continuation application of International Patent Application No. PCT/CN2023/130863, filed on Nov. 9, 2023, which is based on and claims priority to and benefits of Chinese patent application number 202211469151.2, filed on Nov. 22, 2022, titled “Recommendation Data Processing Method, Recommendation Method, and Electronic Device and Storage Medium.” The entire content of the aforementioned applications is incorporated herein by reference.

### TECHNICAL FIELD

This application relates to the field of recommendation data processing method, recommendation method, and electronic device and storage medium.

### BACKGROUND

With the development of computer technology, the portability of computer products has improved, leading to a significant increase in the production and use of such products. Consequently, the connection between computer products and people's daily lives has become closer. Users can access the network data they need through computer products at any time and in various scenarios. To better serve users, network data providers estimate data that might interest users to generate recommendation data, which is then recommended to them. As the volume of network data continues to grow, the range of data information available to users has become broader, and the variety and quantity of data have increased significantly. How to provide users with recommendation data that better matches their actual needs, guide them in obtaining relevant network data, and fulfill their intended purposes for using the network has become a problem in data processing technology that requires improvement.

### SUMMARY

The embodiments of this application provide a recommendation data processing method, a recommendation method, an electronic device, and a storage medium to achieve more efficient data recommendation.

In a first aspect, an embodiment of this application provides a method for processing recommendation data, including: obtaining first definition information regarding a target scenario, wherein the first definition information is generated based on a knowledge graph related to the target scenario, the target scenario being a scenario involving at least one category of objects, and the first definition information comprises the at least one category of objects; obtaining second definition information about the target scenario based on the first definition information, wherein the second definition information comprises a combination of target categories including at least one target category from the at least one category; generating recommendation data for an object corresponding to the combination of target categories based on the second definition information. In one embodiment, the at least one category of objects comprises a plurality of categories of objects.

In a second aspect, an embodiment of this application provides a recommendation method for a server, including: receiving a data request from a client; determining recommendation data based on the data request; the recommendation data corresponds to any of the embodiments of recommendation data provided in this application; delivering the recommendation data to a target module on a user application terminal.

In a third aspect, an embodiment of this application provides a recommendation data processing method for a client, including: generating a recommendation data request based on a user's operation information; sending the recommendation data request to a server; receiving the recommendation data sent by the server based on the recommendation data request; the recommendation data corresponds to any of the embodiments of recommendation data provided in this application or filtered recommendation data.

In a fourth aspect, an embodiment of this application provides an electronic device, including: a memory; a processor; and a computer program stored in the memory, wherein the processor executes the computer program to implement any of the methods described above.

In a fifth aspect, an embodiment of this application provides a computer-readable storage medium, wherein the computer-readable storage medium stores a computer program that, when executed by a processor, implements any of the methods described above.

Compared with the prior art, this application has the following advantages:
according to the method provided in the embodiments of this application, it is possible to determine the first definition information obtained from the knowledge graph for a target scenario, thereby identifying all categories of objects within the target scenario. Subsequently, the second definition information is determined, generating all possible combinations of the categories within the target scenario. Finally, based on the combinations included in the second definition information, recommendation data regarding the objects is obtained. As a result, it becomes possible to recommend relevant data to the user. This allows users, even when they have only vague search needs and are unsure of specific object names or search terms, to access specific data content based on the recommendation data regarding the objects. This saves users' search time and simplifies the planning or preparatory steps required when searching for data.

The above description is merely an overview of the technical solutions provided by this application. To gain a clearer understanding of the technical means, the embodiments described herein can be implemented. Moreover, to make the objectives, features, and advantages of this application more apparent and comprehensible, specific embodiments of this application are presented below.

### BRIEF DESCRIPTION OF THE DRAWINGS

In the accompanying drawings, unless otherwise specified, the same reference numerals across a plurality of figures denote the same or similar components or elements. These drawings are not necessarily drawn to scale. It should be understood that the drawings merely illustrate some embodiments of this application and should not be construed as limiting the scope of the application.

FIG. 1A-1C is a schematic diagrams of scenarios for the recommendation data processing method provided by this application.

FIG. 2 is a flowchart of the recommendation data processing method according to one embodiment of this application.

FIG. 3A-3D is a schematic diagrams of interfaces in the embodiments of this application.

FIG. 4 is a schematic diagram of the modules involved in the embodiments of this application and the operational steps of each module.

FIG. 5 is a schematic diagram of a recommendation data processing device according to one embodiment of this application.

FIG. 6 is a block diagram of an electronic device for implementing the embodiments of this application.

### DETAIL DESCRIPTION OF THE EMBODIMENTS

In the following, certain exemplary embodiments are briefly described. As those skilled in the art will recognize, the described embodiments may be modified in various ways without departing from the spirit or scope of this application. Therefore, the accompanying drawings and descriptions are to be regarded as illustrative rather than limiting.

To facilitate understanding of the technical solutions in the embodiments of this application, the following describes the relevant technologies associated with the embodiments. These relevant technologies, as optional solutions, can be combined with the technical solutions of the embodiments in any manner, all of which fall within the scope of protection of this application.

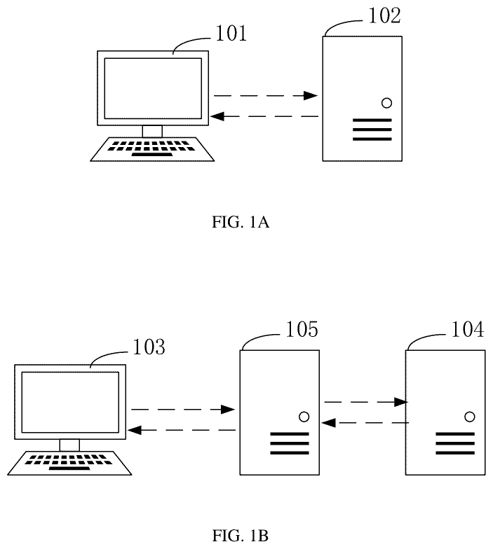

FIG. 1A, FIG. 1B, and FIG. 1C are schematic diagrams of exemplary application scenarios for implementing the methods described in the embodiments of this application. As shown in FIG. 1A, the recommendation data processing method provided by the embodiments of this application can be applied to a system including a server 102 and a client 101. This method is used to recommend specific types of objects, such as news recommendations, encyclopedia knowledge recommendations, service personnel recommendations, service organization recommendations, tourist attraction recommendations, product recommendations, or article recommendations.

Referring to FIG. 1A, in one embodiment, the server 102 determines the recommendation data for user recommendations based on various accessible data and information. When the client 101 sends a data request to the server 102, at least a portion of the recommendation data is selected and sent to the client 101. When the server 102 sends recommendation data to the client 101, it can select recommendation data corresponding to the specific client 101 based on the client's browsing history, specific attribute information, and other relevant details.

Still referring to FIG. 1A, in another embodiment, the server 102 can provide data for constructing knowledge graphs. The client 101 can retrieve this data and, in combination with user-related information stored locally on the client 101, generate or update the scenarios to which the objects belong. Based on the generated scenario information and presentation timing, the client 101 presents the relevant information to the user.

As shown in FIG. 1B, the recommendation data processing method provided by this application can also be applied to a system including a plurality of servers and a client 103. A plurality of servers can perform different functions when calculating recommendation data, such as a database server 104 and a computation server 105. The database server 104 can store various types of relevant information and construct knowledge graphs based on this information. The computation server 105 can generate new scenarios for product applications or update existing scenarios based on the knowledge graphs stored in the database server 104. For example, when the object is a product: the target scenario refers to the context in which the product is used, i.e., the usage scenario of the product. For a mountaineering tent, the primary usage scenario is a mountaineering context, so when the product is a mountaineering tent, the target scenario can be mountaineering. For ice skates, the usage scenario is ice skating, so when the product is ice skates, the target scenario can be winter sports. For a laptop, the usage scenarios may include office work or online entertainment. Thus, when the product is a laptop, the target scenarios can be an office environment or a network entertainment setting. All product usage scenarios can be stored in the database server 104 or the computation server 105. Based on the latest usage scenario information for a product, the categories within the product's usage scenario can be determined. A single category corresponds to a specific type of product. A single usage scenario for a product can correspond to a plurality of categories, meaning it can correspond to a plurality of different types of products.

As shown in FIG. 1C, the recommendation data processing method provided in this application can also be applied to a system including a plurality of servers and a client 106. Among the plurality of servers, a main server 107 and a plurality of sub-servers 108 can be configured. The main server 107 can generate all scenarios involving all objects based on information such as knowledge graphs. It can then distribute the generated scenarios to each sub-server 108 based on their attributes, such as geographic location, the field of responsibility, or the availability of software and hardware resources. Each sub-server 108, in turn, recommends the object data, including a plurality of categories within the relevant scenarios, to the client 106.

In another implementation, if the data related to the objects recommended by the server to the client requires filtering, the filtering operation can be performed either on the server side or on the client side.

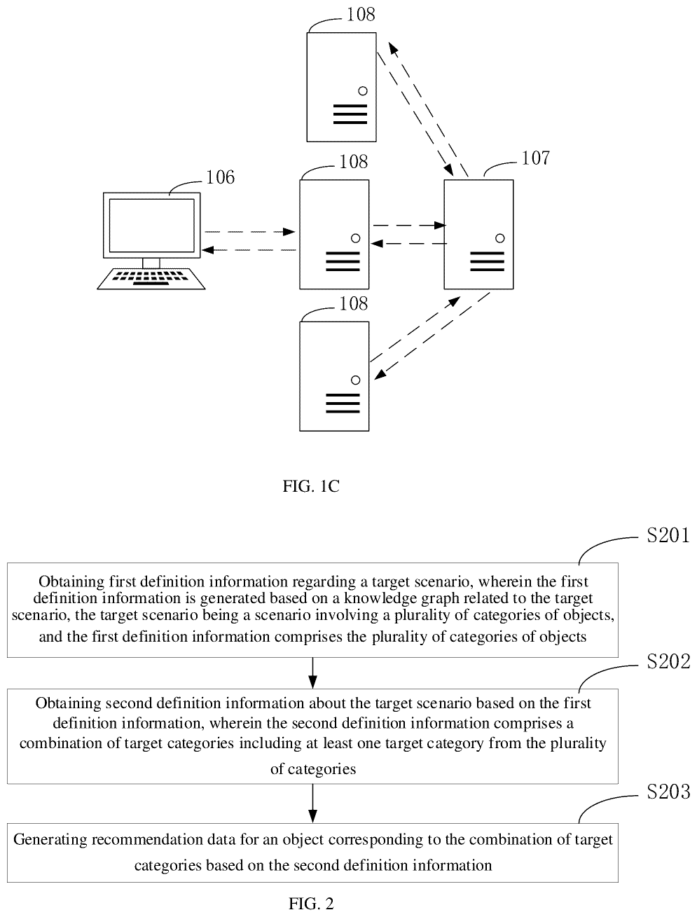

This application provides a recommendation data processing method. FIG. 2 illustrates a flowchart of the recommendation data processing method according to one embodiment of this application, which may include steps S201 to S203. In the embodiment of this application, the method shown in FIG. 2 can be applied to either a client or a server.

In S201, obtaining first definition information regarding a target scenario, wherein the first definition information is generated based on a knowledge graph related to the target scenario, the target scenario being a scenario involving at least one category of objects, for example, a plurality of categories of objects, and the first definition information comprises the plurality of categories of objects.

In the embodiments of this application, the target scenario can be one of a plurality of predefined scenarios. Both predefined scenarios and target scenarios can refer to scenarios involving one or more categories of objects. Different scenarios include different categories. For example, when the object is a news report, all news may involve various scenarios, such as sports, national affairs, entertainment, nature, livelihood, and culture. Thus, a plurality of predefined scenarios may include sports, national affairs, entertainment, nature, livelihood, and culture. The target scenario can be one of the various scenarios that the object may involve. The aforementioned news reports may include news articles, news video clips, and news topic discussions.

In the embodiments of this application, the first definition information may include conceptual description information of the target scenario determined based on the knowledge graph. For example, when the object is a tourism activity, the scenarios that may be involved include historical culture, shopping paradises, plain landscapes, mountain and river landscapes, and seaside landscapes. If “historical culture” is selected as the target scenario, the conceptual description information included in the first definition information may include: scenic spots related to historically significant events or figures; or information associated with historically significant events, as determined based on the knowledge graph.

In the embodiments of this application, the first definition information may also include the nodes within the knowledge graph corresponding to the target scenario. Each node represents an entity, such as Park A, Mall B, or Person C. For example, when the object is a tourism activity and “shopping paradise” is selected as the target scenario, the nodes in the knowledge graph included in the first definition information may include: names of large shopping malls, names of specialty stores, and names of product brands, among others.

In the embodiments of this application, if the first definition information includes a conceptual description of the target scenario or the nodes within the knowledge graph corresponding to the target scenario, the conceptual description or the nodes in the knowledge graph can be used to determine at least one category of the target scenario.

In some embodiments, a category can refer to the classification to which an object belongs. Predefined scenarios and target scenarios can be collectively referred to as scenarios. The categories included in a predefined or target scenario can represent all classifications that the objects within the scenario belong to or are associated with. For example, when the object is a service organization, the plurality of categories under a tourism scenario may include: hotel service organizations, recreation service organizations, and transportation service providers. Here, “tourism” is the scenario, while “hotel service organizations,” “recreation service organizations,” and “transportation service providers” are the categories under the scenario. The categories within a scenario can be considered subcategories corresponding to the scenario.

In one embodiment of this application, the object can be a product, and the target scenario can be one of a plurality of predefined scenarios. Predefined scenarios may represent the application scenarios (usage scenarios) of a product. For example, predefined scenarios may include: home, horseback riding, mountaineering, swimming, skincare, beauty, clothing, office, and digital electronics. Each predefined scenario can correspond to first definition information. For instance, the first definition information for a home scenario may include the conceptual description of “home” and the categories encompassed within the home scenario. The categories included in the home scenario represent the types of products under the home scenario, such as: tables and chairs, beds, cabinets, air conditioners, refrigerators, computers, lights, washing machines, bookshelves, and kitchenware. At the same time, the home scenario is also the shared scenario involving a plurality of products, such as tables and chairs, beds, cabinets, air conditioners, refrigerators, computers, lights, washing machines, bookshelves, and kitchenware.

In S202, obtaining second definition information about the target scenario based on the first definition information, wherein the second definition information comprises a combination of target categories including at least one target category from the plurality of categories.

In some embodiments, when there are N categories under the target scenario, M categories out of these N categories can be combined according to certain combination rules to form at least one combination, where M is less than or equal to N. For example, if there are N categories under the target scenario, four categories can be selected from the N categories to form a combination. However, the four categories included in each combination are not just any arbitrary four categories from the N categories; they must conform to specific combination rules.

In some embodiments, at least one target category can be a category selected from the plurality of categories included in the target scenario according to predefined combination rules. The predefined combination rules may include: quantity conditions for target categories: for example, each combination under the target scenario must include N categories. Association conditions for target categories: for example, the N categories in each combination must have related uses. Additionally, combinations can correspond to predefined templates. Each template may include: primary category: the central or most significant category in the combination. Supplementary categories: the remaining categories in the combination apart from the primary category. The settings and presentation methods for the primary and supplementary categories can also be preconfigured in the template.

For example, when the object is a product and the target scenario is home, the predefined combination rules may include: each combination must include 3 (or 4, 5, etc.) target categories. These 3 target categories must have a mutual dependency relationship in their use. Based on these rules, the following combinations can be formed: bedding combination: quilt cover, duvet core, and bed sheet; refrigerator combination: refrigerator, refrigerator deodorizer, and refrigerator decorative stickers; laundry combination: washing machine, laundry detergent, and fabric softener. Each combination reflects a logical grouping of related products based on their interdependent usage within the home scenario.

In some embodiments, the second definition information may include all combinations under the target scenario. The specific products included in different combinations under the target scenario may overlap. For example, if the target scenario includes six categories A1 to A6, the second definition information may include all combinations within the target scenario: Combination 1: {A1, A2, A3}; Combination 2: {A2, A3, A4}; Combination 3: {A3, A4, A5}; obtaining the second definition information for the target scenario based on the first definition information can involve: identifying the categories from the first definition information; generating combinations of the categories; using these combinations as the second definition information.

S203: generating recommendation data for an object corresponding to the combination of target categories based on the second definition information.

In some embodiments, generating recommendation data regarding the object based on the second definition information can involve: using the attributes and related data of all categories corresponding to the first definition information. Selecting one or more combinations from the second definition information. Identifying the specific data of the target categories corresponding to the selected combination(s). The specific data of the target categories in the selected combination(s) is then used as the recommendation data regarding the object.

For example, when the object is a knowledge encyclopedia, predefined scenarios may include plants, animals, literature, geography, chemistry, mechanics, and electronics, among others. If the target scenario is animals, the first definition information under the animal scenario includes all categories with encyclopedia explanations of concepts and the relationships between these concepts. The second definition information includes a plurality of combinations, such as: marine animals, temperate animals, tropical animals, rare animals, protected animals, poisonous animals, amphibians. From the various combinations included in the second definition information, marine animals are selected as the combination corresponding to the recommendation data. The encyclopedia information on animals included in the marine animal category is then used as the recommendation data for the knowledge encyclopedia.

For another example, when the object is a product, the predefined scenarios may include home, fitness, swimming, mountaineering, travel, office, parties, parenting, pets, clothing, and beauty, among others. If mountaineering is selected as the target scenario: the first definition information includes all product categories related to mountaineering, as well as the relationships between these products. The second definition information includes combinations of categories under the mountaineering scenario, such as: mountaineering essentials, mountaineering clothing, mountaineering footwear, long-duration mountaineering gear, short-duration mountaineering gear, mountaineering safety equipment. From the plurality of combinations in the second definition information, mountaineering clothing is selected as the combination corresponding to the recommendation data. The products included in the mountaineering clothing category are then used as the recommendation data for the product.

In some embodiments, generating recommendation data regarding the object based on the second definition information can involve: using the second definition information and specific client-related information (e.g., user preferences, history, or attributes). Selecting at least one combination from the combinations corresponding to the second definition information. Using the data of the objects in the selected combination as the recommendation data for the object. This process ensures that the recommendation data is tailored to the client's specific context or needs, providing more relevant and personalized recommendations.

In some embodiments of this application, the client information may include: client's location information, browsing history, interest information provided by the client, predicted information about topics of interest to the client.

In some embodiments, the client's location information may include, and/or Specific location information: the precise geographical coordinates of the client. The client's location information can be obtained under the following conditions: permission-based access: if the client grants permission, the location information can be retrieved using a location system (e.g., GPS). Inference from related data: if the client grants permission, the location information can be inferred from other related data, such as hotel bookings, flight reservations, or train ticket purchases. Categorical information about the client's location: classifications of the client's region, such as: domestic regions, overseas regions, Hong Kong, Macau, and Taiwan regions.

In one embodiment of this application, client information, such as the client's location information, can be used to predict the client's need for recommendation data. Based on the predicted results and the second definition information, the recommended data for the object can be determined.

For example, when the object is a product, and the client's location classification is overseas, the client's demand for purchasing products is predicted. The prediction result includes: the client needs to make bulk purchases. From the second definition information, at least one combination is selected. The products corresponding to the selected combination that are suitable for bulk purchasing will be identified, and relevant data (such as product links, store names, etc.) will be provided as the recommended data for the product.

In another embodiment of this application, determining the recommended data for the object based on the second definition information can involve: using the categories within the second definition information to identify the specific object details for each category in the combinations being recommended. The specific information of the object is then used as the recommended data for the object. The specific object information may include details such as a specific webpage, links, or other relevant data associated with the object.

In the embodiments of the application, the process involves: determining the first definition information for the target scenario based on the knowledge graph, obtaining all categories of objects within the target scenario; determining the second definition information, which provides all combinations of the categories that can be formed under the target scenario; generating recommendation data for the object based on the combinations included in the second definition information. By following this approach, relevant data can be recommended to the user. This enables users to obtain specific data content even when they have only a vague search requirement and are unsure of the exact object name or search term. As a result, the user can save time and simplify the planning or preparation activities needed when searching for data.

In one embodiment of this application, the method for processing recommendation data further includes: obtaining the first update information of the knowledge graph; based on the first update information, generating a new scenario; using the newly generated scenario as the target scenario.

In the embodiments of the application, the data in the knowledge graph is continuously accumulating over time. During each set update information retrieval cycle, the first update information of the knowledge graph is obtained. Some of the update information in the first update may be unrelated to the current scenarios, in which case, a new scenario can be generated based on the first update information and used as the target scenario. For example, as the cost of purchasing mobile devices increases, a new scenario related to the protection and usage of mobile devices may emerge. This new scenario can be used to update the recommendations and provide relevant data to the user based on the evolving context.

In the embodiments of the application, new knowledge graph data can be used to generate new scenarios. By using these new scenarios as the target scenario, the number of available scenarios can continuously increase and enrich. This ensures that the system stays up-to-date and offers a broader range of relevant recommendations, adapting to new trends and emerging data.

In one embodiment of this application, the method for processing recommendation data further includes: obtaining the second update information of the knowledge graph; based on the second update information, updating existing scenarios to obtain the updated scenarios; using the updated scenarios as the target scenario.

In the embodiments of the application, existing scenarios refer to those that have been generated prior to obtaining the second update information. The data corresponding to these generated scenarios in the knowledge graph is not fixed and may change over time. For example, with market development, the dominant position of mobile device brands in the market may change, which can lead to changes in product supply, product usage methods, and news hotspots. As a result, this can cause changes in the categories within existing scenarios and the combinations that may form from these categories. These changes can be reflected in the updated scenarios when the second update information is applied.

In the embodiments of the application, updating existing scenarios can involve: adding categories within the scenario. For example, with the development of international communication, when the object is news, the international scenario could add a category related to international exchanges; removing categories within the existing scenario; adjusting combinations included in the existing scenario.

In the embodiments of the application, updating existing scenarios can also involve updating both the first definition information and the second definition information of the existing scenarios.

In the embodiments of the application, updating existing scenarios ensures that the generation of recommendation data remains highly consistent with the current user group's thinking, preferences, interests, and areas of focus. This allows the system to provide more relevant and personalized recommendations that align with the evolving needs and behaviors of the users.

In one embodiment of this application, the second definition information for the target scenario is obtained based on the first definition information, which includes: determining at least one target category combination from a plurality of categories, based on the relationships between different categories; generating the second definition information based on the combination of at least one target category.

In the embodiments of the application, determining at least one target category combination from a plurality of categories based on the relationships between different categories may include: determining the relationships between categories based on the instructions of an operator; based on these relationships, selecting at least one target category combination from the plurality of categories. In some embodiments, the operator can be a staff member on the server side. In cases where the object is a product, the operator can also be a merchant on the client side. The merchant can choose and configure the products included in the combination based on their supply capabilities and the compatibility of the available inventory.

In the embodiments of the application, determining at least one target category combination from a plurality of categories based on the relationships between different categories can also include: determining the relationships between categories based on the attribute information corresponding to each category in the knowledge graph; based on these relationships, selecting at least one target category combination from the plurality of categories.

In one embodiment, the combinations included in the second definition information can be determined using a predefined scenario grouping platform. When determining the combinations included in the second definition information, the grouping platform can: using a preset template to obtain relevant information. Combine the obtained information with the template to generate the combinations.

In some embodiments, combinations under the target scenario can be determined based on the relationships between categories. This allows for the identification of recommendation data based on these combinations, ensuring that the recommendation data aligns as closely as possible with the client's user needs. By considering the relationships between categories, the system can provide highly relevant and personalized recommendations.

In one embodiment of this application, when the object is a product, the process for generating recommendation data based on the first and second definition information includes: for each target category, determining the set number of target products corresponding to the target category; forming a target product set for each combination, consisting of the target products corresponding to the set number for each target category in the combination. This set represents the target recommended products for the combination; adding the target recommended product set to the candidate recommendation data corresponding to the target category combination; based on the candidate recommendation data, generating the final recommendation data.

In the embodiments of the application, the target product refers to a specific product. For example, a target category can be clothing, food, or any other category. Since there may be thousands or even more specific products in the clothing category, each individual product can correspond to a webpage, link, or other data carriers. In some embodiments, the target product is a specific item. For the clothing category, the target product could be a specific item like clothing C1, which corresponds to a specific link C2 or webpage C3. The target product set formed by the target products corresponding to each target category may include one or more sets. For example, a combination of clothing, food, and shoes forms a set, with clothing, food, and shoes being the target categories. For each target category, a specific product is selected as the target product: in the clothing category, clothing C1 is selected as the target product, and it corresponds to a specific product purchase link C1 or query webpage C1. In the food category, food F1 is selected as the target product, and it corresponds to a specific product purchase link F2 or query webpage F2. In the shoes category, shoes S1 is selected as the target product, and it corresponds to a specific product purchase link S3 or query webpage S3. Thus, clothing C1, food F1, and shoes S1 form a target product set for the combination of clothing, food, and shoes.

In the embodiments of the application, the candidate recommendation data corresponding to the combinations of target categories may include a plurality of target product sets. For example, a combination of clothing, food, and shoes may include a plurality of target product sets, such as: {Clothing C1, food F1, shoes S1},{Clothing C2, food F2, shoes S2}, {Clothing C3, Food F3, Shoes S3}, {Clothing C4, Food F4, Shoes S4}, {Clothing C5, Food F5, Shoes S5}, and so on. Each target product set includes elements that are specific products, each of which corresponds to a particular product with a link or query webpage for purchasing or further details.

In the embodiments of the application, determining the target product corresponding to the target category can involve selecting the recommended product for the target category. Generally, a target category corresponds to a specific product, but a product may have a plurality of data sources, such as different purchase links, which may correspond to different suppliers. When generating recommendation data, if all products in a category are presented to the user, it could result in the user spending a significant amount of time filtering options, or experiencing difficulty in making a choice, which reduces the efficiency of the purchasing process. In some embodiments, by selecting the target product for each target category and using it as the recommendation data, the system helps save the user's time in both selecting related products and narrowing down options within the same category. This approach enhances the efficiency of the user's decision-making process.

In one embodiment of this application, the process of generating recommendation data based on the candidate recommendation data includes: selecting the recommended product set to be recommended from the candidate recommendation data corresponding to the target category combinations. The candidate recommendation data includes a plurality of recommended product sets, and each set contains at least one product, with some sets including the target recommended product set; based on the selected recommended product set, the final recommendation data is generated.

In the embodiments of the application, the candidate recommendation data includes a certain number of target product sets. From the candidate recommendation data corresponding to the combinations of target categories, the recommended product set to be recommended is selected. This process can involve: selecting at least one target product set from the target product sets included in the candidate recommendation data; using the selected target product set as the recommended product set to be recommended.

For example, the target product sets included in the candidate recommendation data are: {Clothing C1, Food F1, Shoes S1}, {Clothing C2, Food F2, Shoes S2}, {Clothing C3, Food F3, Shoes S3}, {Clothing C4, Food F4, Shoes S4}, {Clothing C5, Food F5, Shoes S5}. a selection of some of the target product sets is made, namely: {Clothing C1, Food F1, Shoes S1}, {Clothing C2, Food F2, Shoes S2}, {Clothing C3, Food F3, Shoes S3}. These are selected as the recommended product set to be recommended.

In some embodiments, at least one set is selected from the target product sets included in the candidate recommendation data as the recommended product set to be recommended. This allows a plurality of groups of products to be recommended to the user in the form of combinations.

In one embodiment of this application, based on the recommended product set to be recommended, the recommendation data is generated, which includes: determining the cover of the recommendation data based on the recommended product set; using the cover as the presentation interface for the recommendation data; generating the landing page to be displayed when the presentation interface is clicked, based on the products in the recommended product set. The recommendation data thus includes both the presentation interface and the landing page.

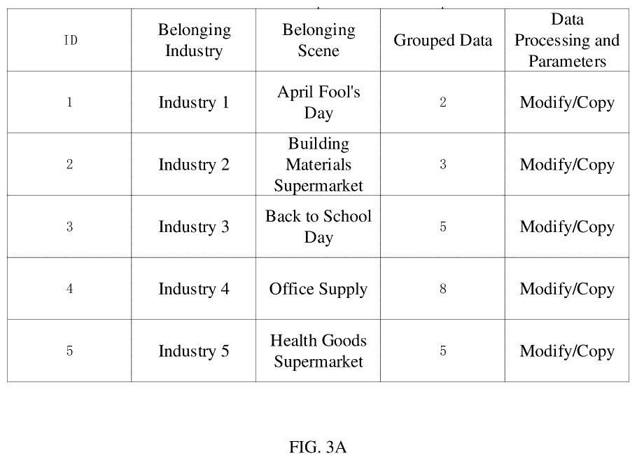

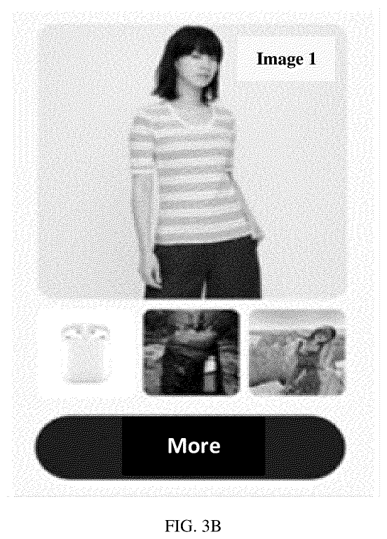

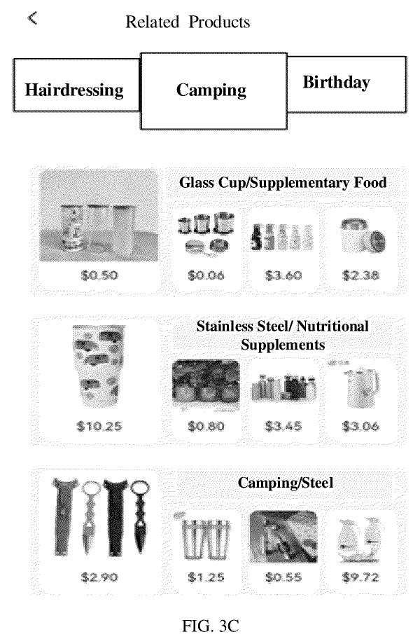

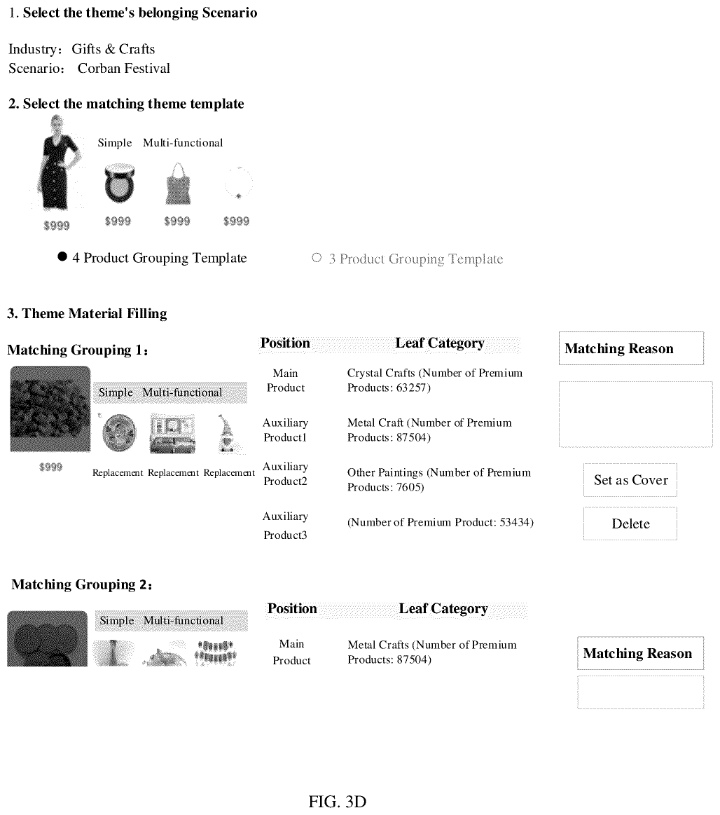

In the embodiments of the application, determining the cover of the recommendation data based on the recommended product set may include: selecting the image to be used in the cover based on the product images in the recommended product set; using the selected image to determine the cover of the recommendation data. One example of the cover (presentation interface) is shown in FIG. 3B. In one embodiment, the landing page may also be referred to as a redirect page.

In the embodiments of the application, at least one set of target product sets can be displayed in both the presentation interface of the recommendation data and the landing page after clicking on the presentation interface. This improves the efficiency of user interaction with the interface.

In one embodiment of this application, based on the products in the recommended product set, the landing page (redirect page) is generated after the presentation interface is clicked, which includes: obtaining the main product and auxiliary products from the recommended product set. The main product has a higher priority in the recommendation order than the auxiliary products. Based on the main product and auxiliary products, determining the display content for the display area corresponding to the recommended product set on the landing page; generating the landing page based on the display content in the display area.

In the embodiments of the application, both the main product and the auxiliary products can be items from the target product set. In the target product set, at least one product can be set as the main product, and the remaining products can be set as auxiliary products. The display priority of the main product is higher than that of the auxiliary products, which helps to identify the products most likely to attract the user's attention from the target product set. These products are then placed in a prominent position to engage the user, while also allowing the user to quickly and intuitively understand the product overview of the target product set in a short amount of time.

In the embodiments of the application, the configuration interface for the presentation interface and the landing page can still be referenced as shown in FIGS. 3A and 3D. One implementation example of the landing page is shown in FIG. 3C.

In the embodiments of the application, the cover image of the recommended product is displayed on the presentation interface of the recommendation data, while the landing page of the recommended product is shown on the landing page. On the landing page, the main products and auxiliary products corresponding to each combination in the recommendation data are presented. This approach improves the user interface (UI) efficiency when presenting the recommended products to users through the presentation interface and landing page, enhancing user interaction.

The embodiments of the application also provide a recommendation method for the server side, which includes: receiving a data request from the client; determining the recommendation data based on the data request; recommending the recommendation data to the target module of the client-side user application. The recommendation data is the data generated in any of the embodiments described in this application.

In one embodiment of this application, recommending the recommendation data to the target module of the user application includes: determining the filtered data based on the client's data request; filtering the recommendation data using the filtered data to obtain the filtered recommendation data; sending the filtered recommendation data to the target module of the user application on the client side. This process ensures that the recommendation data sent to the client is tailored and refined based on the specific request from the user.

In the embodiments of the application, the filtered data can be the data carried by the client's data request, or data generated based on the data carried in the client's request. The client's data request may include information about specific objects that the user has viewed in the most recent statistical period (e.g., in the past week, if the user has viewed articles A1, A2, A3, and the recommendation data originally includes any of these three articles, A1, A2, or A3 will be removed from the recommendation data accordingly). This way, the recommendation data can filter out specific objects that the user has recently viewed, avoiding redundant recommendations and improving the relevance of the recommendations for the user.

The specific object information that the user has viewed may include any one of the specific object information that was exposed to the user and the specific object information that the user clicked on. The specific object information exposed to the user refers to the information about objects that were shown on the display interface to the user but were not specifically accessed or clicked by the user, indicating that the user did not actively view them. This allows for filtering out items that the user has been exposed to but did not engage with, further refining the recommendation process.

In one embodiment of this application, the target module on the user application terminal is used to process data related to the purchasing behavior of commercial users. A commercial user is defined as a user whose product purchase quantity information in the product purchase orders meets predefined conditions. This could refer to users who make purchases in larger quantities or other criteria set by the system for classifying commercial buyers.

In some embodiments, the commercial users are referred to as B-class (Business) users. B-class users include individuals or businesses using the B-end for shopping. These users typically place large orders, often for wholesale purposes or for stocking products, and they tend to have high demand for specific types of goods. They may also require a significant number of associated products related to the items they have ordered. These embodiments allow for product recommendations tailored to commercial users, making it easier for them to order the related products.

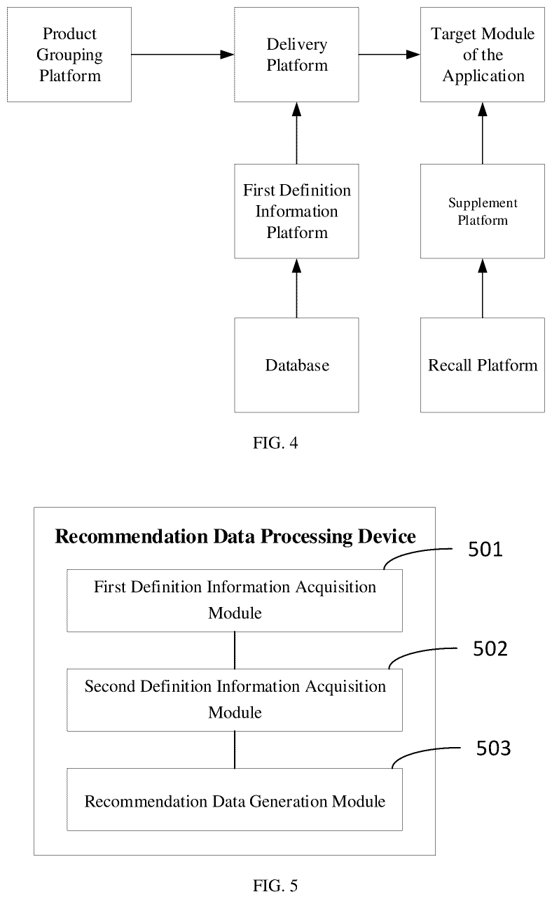

In the embodiments of the application, the various processing platforms and corresponding operations involved in the recommendation method are shown in FIG. 4. The platforms include: grouping platform: used to acquire the second definition information as mentioned in the previous embodiments; delivery platform: used to generate recommendation data based on the first and second definition information; first definition information platform: used to generate the first definition information based on the knowledge graph in the database; recall platform and supplement platform: these platforms record information about the objects the user has viewed. The recorded data is used to improve the recommendation data or to filter out redundant exposure or recommendation data that the user has already seen.

The embodiments of the application also provide a recommendation data processing method for the client side, which includes: generating a recommendation data request based on the user's operation information; sending the recommendation data request to the server side; receiving the recommendation data sent by the server side in response to the recommendation data request. The recommendation data can be the data that has been filtered according to the embodiments of this application.

In the embodiments of the application, the user's operation information may include: information about the user entering the designated entry point of the application, information about the user actively sending a recommendation data request, information about the user refreshing the existing recommendation data.

In one embodiment of this application, generating a recommendation data request based on the user's operation information includes: obtaining a record of the operation information; based on the record, determining the products the user has viewed; using the viewed products as filtered data and adding them to the recommendation data request.

In one embodiment of this application, the recommendation data processing method further includes: based on the user's first operation, determining the combination in the recommendation data that needs to be processed; based on the user's second operation, handling the bulk processing information of the products in the combination that needs to be processed; sending the bulk processing information.

The aforementioned first operation and second operation can either be the same operation or different operations, and are used to perform bulk actions on the products in the combination to be processed, such as bulk inquiries, bulk additions to the shopping cart, or other batch processing actions.

In the embodiments of the application, a recommendation data processing method is provided, including the following operations executed on the server side and client side: on the client side: based on the user's operation information, the client generates a recommendation data request; the client sends the recommendation data request to the server; the server receives the data request from the client; the server determines the recommendation data based on the client's data request; the server recommends the recommendation data to the target module of the client-side user application.

In the case where the objects are products, the buyers can be categorized into domestic buyers and international buyers. When providing products, different product browsing main links and product links under those main links can be offered to the corresponding users on the client side based on the buyer's international or domestic attributes. For example, when providing product data, the website offered to product purchasing customers or end users can be divided into: a country domestic site: corresponding to the client side of domestic customers in country A and country A international site: corresponding to the client side of international customers from Country A.

In general, the multi-category procurement on international sites may have issues with low efficiency. When buying products, buyers (customers) need to search for each individual product one by one. This involves performing actions like entering search terms, filtering single products, and selecting links for individual products. Buyers also have to communicate with different merchants (sellers) individually, and they cannot easily identify merchants with multi-category product grouping capabilities. Additionally, the logistics costs in the transaction fulfillment process are relatively high. Merchants' ability to group products and their service advantages are not highlighted, and it becomes difficult to precisely identify target buyers, leading to missed business opportunities for the merchants.

In one example of this application, when the objects are products, customers (buyers) are divided into domestic buyers and international buyers. Domestic buyers generally have retail demand and usually only need to purchase a single item for the same product category. In contrast, international buyers, due to reasons such as shipping costs, typically have larger order quantities. From the perspective of both the merchant and the buyer, merchants prefer that users purchase as many items as possible in a single order to maximize the value of the international shipping costs.

Additionally, in general, among international buyers, only 35.3% of users have clear procurement goals. A larger portion of buyers arrive at international sites with more vague purchasing needs and hope to gain procurement inspiration from the platform. Even buyers with relatively clear purchasing demands continue to explore new procurement needs, indicating that there is significant potential to stimulate latent demand.

Based on the analysis of the pain points or demand points of international buyers and sellers, the embodiments of the application can recommend related products to buyers. After purchasing an item or while browsing a product-providing website or application, the system can provide other related products based on the buyer's needs. For example, in a mountain climbing scenario, if a user purchases a mountain climbing tent, the system can recommend other combinations related to this scenario, such as a mountain climbing water bottle, backpack, and mountain climbing shoes. This allows users with mountain climbing needs to easily obtain information about other products related to the climbing scenario, reducing the time spent deciding which product category to choose. It also saves time in selecting specific items and helps improve sales volume by offering relevant product recommendations.

The main innovation of the embodiments in this application lies in systematically mining cross-category purchasing scenarios. By using industry expertise and algorithmic recommendations, the system creates product combinations to inspire B-class buyers (as referred to in the previous embodiments) and enhance their purchasing inspiration. This approach broadens the demand scope of B-class buyers and strengthens their stickiness to the platform. Additionally, these embodiments help deepen buyers' understanding of specific industries and cross-border B-class buyer purchasing behavior, improving the overall product and service experience. It also helps buyers better understand market trends. Furthermore, the embodiment provides a one-stop product grouping service that is digitized, offering buyers a deterministic and efficient multi-category purchasing service. This service attracts more target buyers for merchants with product grouping capabilities, increases the scale of business opportunities, and improves transaction conversion and transaction volume. Focusing on the practical needs of B-class buyers for one-stop purchasing, this solution targets core industries, expands the scale of trade merchants and integrated industrial and commercial merchants with product grouping capabilities, and provides full-link product grouping services. This ultimately enhances business opportunity matching efficiency, expands transaction volume, and drives revenue growth in the commercial sector.

Additionally, the recommendation data processing method provided in the embodiments of the application use industry operational expertise as input. By systematically mining related purchasing scenarios and generating product combinations, combined with personalized recommendation algorithms (e.g., “one-size-fits-all” recommendations), it helps to inspire buyers' purchasing inspiration and broaden their demand. This provides buyers with richer purchasing combinations, improves sourcing efficiency, and enhances buyer engagement with the platform.

In a specific example, the recommendation data processing method consists of three stages: data processing, scenario configuration, and scenario delivery.

In the data processing stage, the latest updated data of the knowledge graph is synchronized for each update cycle. Based on the most recent data from the knowledge graph, the first definition information for specific scenarios is processed and generated.

In the scenario configuration stage, a scenario is created or an existing scenario is updated on the scenario product grouping management platform, and the combinations within the scenario are configured. The configured combinations are then saved into the business database of the scenario product grouping management platform. At the same time, the related groups are synchronized to the main and auxiliary product determination platform, which provides an online interface for downstream systems to call.

In the scenario delivery stage, the scenario product grouping theme is configured on the delivery platform and deployed to the corresponding module on the homepage of the product providing site. This allows users to browse all the products in the combination at once from the corresponding module.

In one embodiment of this application, different combinations may contain duplicate categories, and when users browse a plurality of times, they may encounter the same products again, which could reduce the efficiency of product selection. To address this issue, it is necessary to ensure that there is no repeated exposure of products within each combination card across different pages in the product waterfall stream. This helps maintain a diverse and efficient browsing experience for users.

In one embodiment, during the combination card process, the products under the categories in the candidate combinations are cached in a queue, where the products in the queue are not duplicated. When selecting products from the combination, the next product in the corresponding queue is used to form the auxiliary product combination. This ensures that products are selected without repetition, maintaining diversity in the product offerings.

Using a queue method can resolve the issue of product repetition during a single request. However, when a subsequent request is made, if the same auxiliary product category is encountered, it becomes difficult to know which products from that category were exposed in the previous request. To address this issue, user authorization can be preemptively obtained. With the user's consent to access their browsing history, the system can save the user's browsing history while they browse the event page. This allows the system to track which products have already been exposed, preventing duplicate exposure in future requests.

The filtering of recommendation data can be implemented using a Bloom Filter. When the client first requests the recommendation data, a Bloom Filter corresponding to the client is created to identify whether a product has been exposed or viewed. When returning recommendation data, the serialized Bloom Filter is provided to the frontend. In subsequent requests, the frontend sends the serialized string, and the backend restores the Bloom Filter based on the serialized content. This approach helps retain the user's browsing history. Moreover, using the Bloom Filter ensures that the transmission size of data packets does not increase with the number of requests, maintaining efficient data handling.

However, serializing the Bloom Filter results in serialized data reaching 24 KB, which imposes a significant overhead on the data packets transmitted between the frontend and backend. After analyzing the serialized text content of the Bloom Filter, the method employs text compression to reduce the overhead of sending the Bloom Filter in requests between the frontend and backend. The compressed text size is reduced to only 4 bytes, and after decompression and decryption, the Bloom Filter can be successfully restored, ensuring that the previously recorded data is not lost. This optimization significantly reduces the data transmission cost while preserving functionality.

In the embodiments of the application, by associating recommendations through the scenario and combinations of objects, industry operational expertise can be transmitted directly to the user, inspiring their purchasing ideas. At the same time, by combining this approach with algorithmic recommendations, it helps solve the cold start issue caused by insufficient initial data when a project is first launched. This allows for a smoother user experience and more relevant product recommendations even in the early stages of the project.

In the process of solving the issue of repeated exposure of auxiliary products, in addition to the de-duplication method based on Bloom Filters described in the solution, other approaches can also be implemented. For example, user requests can be cached in middleware or persisted, such as by using a middleware like Tair that integrates Bloom Filter functionality for caching user requests. However, these solutions involve caching at the user level, which can consume a significant amount of storage resources and incur system overhead, especially for high-traffic e-commerce websites. Additionally, maintaining user data introduces complex logic and can lead to data inconsistency, as well as increased request chains that may result in response timeouts.

In the embodiments of the application, it is typically only necessary to ensure that the product waterfall stream does not have repeated exposure during a single browsing session. Therefore, there is no need to permanently store the user's browsing data. If middleware or persistent storage is used to store the user's browsing data, additional maintenance of this data is required, which increases system complexity and maintenance costs. The de-duplication method based on bloom filters designed in this solution not only avoids imposing additional load on the system but also eliminates the need to maintain user-level product exposure data. This approach not only reduces resource overhead but also lowers maintenance costs, making it a more efficient and cost-effective solution for handling product recommendations.

Corresponding to the application scenarios and methods provided in the embodiments of the application, some embodiments also provide a recommendation data processing device. As shown in FIG. 5, a block diagram of the recommendation data processing device in some embodiments include: first definition information acquisition module 501, used to acquire the first definition information about the target scenario. The first definition information is generated based on the knowledge graph related to the target scenario and includes a plurality of categories within the target scenario; second definition information acquisition module 502, configured to acquire the second definition information about the target scenario based on the first definition information. The second definition information includes at least one combination of target categories. The plurality of categories include at least one target category; recommendation data generation module 503, configured to generate recommendation data about the objects based on the second definition information.

In the embodiments of the application, the device shown in FIG. 5 can be applied to either the client side or the server side.

In one embodiment, the recommendation data processing device further includes: first update information acquisition module, configured to responsible for acquiring the first update information from the knowledge graph. New scenario generation module: this module generates new scenarios based on the first update information.

New scenario update module: this module updates the new scenario as the target scenario.

In one embodiment, the recommendation data processing device further includes: second update information acquisition module responsible for obtaining the second update information from the knowledge graph; existing scenario update module, configured to update existing scenarios based on the second update information to obtain the updated scenarios; existing scenario processing module: this module processes the updated scenarios and sets them as the target scenario.

In one embodiment, the second definition information acquisition module includes: combination determination unit, configured to determine the combination of target categories including the at least one target category from the plurality of categories, based on relationships between different categories of the plurality of categories; combination processing unit, configured to generate the second definition information based on the combination of target categories.

In one embodiment, when the objects are products, the recommendation data generation module includes: target product determination unit, responsible for determining the target products corresponding to each target category of the combination of target categories; recommended product set unit, configured to form the target product set by combining the target product corresponding to each target category, and use this set as the target recommended product set for the combination of target categories; candidate recommendation data unit, configured to add the target recommended product set to the candidate recommendation data corresponding to the first definition information; candidate recommendation data processing unit, configured to process the candidate recommendation data to generate the final recommendation data.

In one embodiment, the candidate recommendation data processing unit can also be used to select the recommended product set to be recommended from the candidate recommendation data corresponding to the first definition information. The candidate recommendation data includes a plurality of recommended product sets, where each recommended product set contains at least one product, and the target recommended product set is among these sets. The candidate recommendation data processing unit can also be used to generate the recommendation data based on the recommended product set selected to be recommended.

In one embodiment, the candidate recommendation data processing unit can also be used to determine the cover of the recommendation data based on the recommended product set; use the cover as the presentation interface for the recommendation data; generate the landing page to be displayed when the presentation interface is clicked, based on the products in the recommended product set.

In one embodiment, the candidate recommendation data processing unit can also be used to obtain the main product and auxiliary products from the recommended product set, the main product having a higher priority in the recommendation order compared to the auxiliary products; based on the main product and auxiliary products, determine the display content for the display area corresponding to the recommended product set on the landing page; generate the landing page based on the display content in the display area.

The embodiments of the application also provide a recommendation device for the server side, which includes: data request reception module, configured to receive the data request from the client; recommendation data determination module, configured to determine the recommendation data based on the data request, the recommendation data being the data provided by any of the embodiments in this application; recommendation execution module, configured to recommend the recommendation data to the target module on the user application terminal.

In one embodiment, the recommendation execution module includes: filtered data determination unit, configured to determine the filtered data based on the client's data request; filtering unit, configured to filter the recommendation data based on the filtered data, producing the filtered recommendation data; filtered recommendation data sending unit, configured to send the filtered recommendation data to the target module on the user application terminal.

In one embodiment of this application, the target module on the user application terminal is used to process data related to the purchasing behavior of commercial users; a commercial user is defined as a user whose product purchase quantity information in the product purchase orders meets predefined conditions.

The embodiments of the application also provide a recommendation data processing device for the client side, which includes: recommendation data request generation module, configured to generate the recommendation data request based on the user's operation information; recommendation data request sending module, configured to send the recommendation data request to the server; recommendation data receiving module, configured to receive the recommendation data sent by the server in response to the recommendation data request; the recommendation data is the filtered recommendation data provided in any of the embodiments of this application.

In one embodiment, when the objects are products, the recommendation data request generation module includes: operation record acquisition unit, configured to acquire the record of the user's operation information; viewed product determination unit, configured to determine the products that the user has viewed based on the operation records; filtered data addition unit, configured to add the viewed products as filtered data to the recommendation data request.

In one embodiment, the recommendation data processing device further includes: first operation processing module, configured to determine the combinations to be processed within the recommendation data based on the user's first operation; second operation processing module, configured to handle the batch processing information for the products in the combinations to be processed, based on the user's second operation; batch processing information sending module, configured to send the batch processing information.

In the embodiments of the application, for a target scenario, the first definition information obtained from the knowledge graph is used to determine all the categories of objects under the target scenario. Then, the second definition information is determined to identify all possible combinations of these categories. Finally, based on the combinations included in the second definition information, recommendation data for the objects is generated. This method allows the system to recommend related data to users, enabling users to obtain specific data content even when they have vague search needs and are uncertain about the exact object name or search terms. This helps save users' search time and simplifies the planning or preparatory activities required when searching for data.

In the embodiments of the application, a system is also provided, which includes the recommendation data processing device or recommendation device applied to the server side or client side as described in the embodiments of this application.

The functions of the modules in each device of the embodiments can be referenced in the corresponding descriptions of the methods above, and they provide the respective beneficial effects, which will not be repeated here.

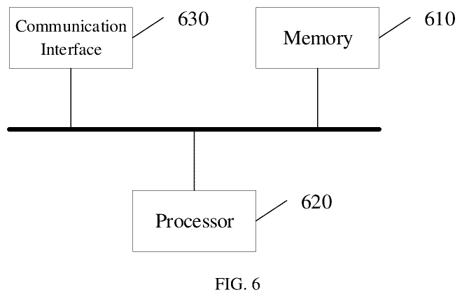

FIG. 6 is a block diagram of an electronic device used to implement the embodiments of this application. As shown in FIG. 6, the electronic device includes: memory 610 and processor 620. The memory 610 is configured to store computer program that can be executed on the processor 620. The processor 620 is configured to execute the computer program, thereby implementing the methods described in the above embodiments. The number of memory 610 and processor 620 can be one or more.

The electronic device further includes:
communication interface 630, configured to communicate with external devices, enabling data exchange and transmission.

If the memory 610, processor 620, and communication interface 630 are implemented independently, they can be interconnected via buses to facilitate communication between them. The buses can be an Industry Standard Architecture (ISA) bus, a Peripheral Component Interconnect (PCI) bus, or an Extended Industry Standard Architecture (EISA) bus, among others. The buses may include components such as an address bus, a data bus, and a control bus. For simplicity in representation, FIG. 6 shows only a single thick line to represent a bus, but this does not imply that there is only one bus or a single type of bus.

Alternatively, in a specific implementation, if the memory 610, processor 620, and communication interface 630 are integrated on a single chip, they can communicate with each other through internal interfaces.

The embodiments of the application provide a computer-readable storage medium that stores a computer program. When executed by a processor, the program implements the methods provided in the embodiments of this application.

The embodiments of the application also provide a chip, which includes a processor. The processor is responsible for invoking and executing instructions stored in the memory. This enables the communication device equipped with the chip to perform the methods provided in the embodiments of this application.

The embodiments of the application also provide a chip, which includes: input interface, output interface, processor, and memory. The input interface, output interface, processor, and memory are connected via an internal communication path. The processor is configured to execute the code stored in the memory, and when the code is executed, the processor performs the methods provided in the embodiments of this application.

It should be understood that the processor mentioned above can be a Central Processing Unit (CPU), or it can be other types of processors such as a general-purpose processor, a Digital Signal Processor (DSP), an Application Specific Integrated Circuit (ASIC), a Field Programmable Gate Array (FPGA), or other programmable logic devices, discrete gates or transistor logic devices, discrete hardware components, and so on. A general-purpose processor can be a microprocessor or any conventional processor. It is also worth noting that the processor can be one that supports the Advanced RISC Machines (ARM) architecture.

Furthermore, optionally, the memory mentioned above may include read-only memory and random access memory. This memory can be volatile or non-volatile, or it may include both volatile and non-volatile types of memory. Non-volatile memory may include Read-Only Memory (ROM), Programmable ROM (PROM), Erasable PROM (EPROM), Electrically Erasable Programmable ROM (EEPROM), or flash memory. Volatile memory may include Random Access Memory (RAM), which serves as an external high-speed cache. By way of example, but not limitation, many forms of RAM are available, such as: Static RAM (SRAM), Dynamic RAM (DRAM), Synchronous DRAM (SDRAM), Double Data Rate SDRAM (DDR SDRAM), Enhanced SDRAM (ESDRAM), Sync Link DRAM (SLDRAM), and Direct Rambus RAM (DR RAM)

In the above embodiments, the implementation can be carried out entirely or partially through software, hardware, firmware, or any combination thereof. When implemented using software, it can be realized entirely or partially in the form of a computer program product. A computer program product includes one or more computer instructions. When the computer program instructions are loaded and executed on a computer, they produce all or part of the processes or functions described in this application. The computer can be a general-purpose computer, a special-purpose computer, a computer network, or any other programmable device. The computer instructions can be stored in a computer-readable storage medium, or they can be transferred from one computer-readable storage medium to another.

In the description of this specification, terms such as “one embodiment,” “some embodiments,” “example,” “specific example,” or “some examples,” refer to particular features, structures, materials, or characteristics described in relation to that embodiment or example, which are included in at least one embodiment or example of this application. Moreover, the specific features, structures, materials, or characteristics described can be appropriately combined in any one or more embodiments or examples. Furthermore, where there is no contradiction, those skilled in the art can combine and integrate the different embodiments or examples described in this specification, as well as the features of different embodiments or examples.

Additionally, the terms “first,” “second,” etc., are used solely for descriptive purposes and should not be understood as indicating or implying relative importance or specifying the number of technical features referred to. Therefore, features defined as “first,” “second,” and so on, may explicitly or implicitly include at least one of that feature. In the description of this application, the term “a plurality of” means two or more, unless otherwise specifically defined.

Any process or method described in the flowchart or otherwise described here can be understood as a module, fragment, or part of executable instructions representing one or more steps for performing specific logical functions or processes. Additionally, the scope of the preferred embodiments of this application includes alternative implementations where the steps may not be performed in the exact order shown or discussed, including performing the functions in a concurrently or reverse order, depending on the functionalities involved.

The logic and/or steps described in the flowchart or otherwise described here can be considered as an ordered list of executable instructions for implementing logical functions. These instructions can be specifically implemented in any computer-readable medium for use by an instruction execution system, device, or apparatus (such as a computer-based system, a system including a processor, or any other system that can fetch instructions from an instruction execution system, device, or apparatus and execute those instructions), or in combination with these instruction execution systems, devices, or apparatuses.

It should be understood that various parts of this application can be implemented using hardware, software, firmware, or any combination thereof. In the above embodiments, a plurality of steps or methods can be implemented using software or firmware stored in memory and executed by a suitable instruction execution system. All or part of the steps of the method in the above embodiments can be completed by a program that instructs the related hardware. This program can be stored in a computer-readable storage medium, and when executed, it includes one or more of the steps or combinations of steps from the method embodiments.

Furthermore, in the various embodiments of this application, the functional units may be integrated into a single processing module, or they may exist as separate physical units, or two or more units can be integrated into a single module. The integrated module can be implemented in hardware form, or it can be implemented as a software functional module. If the integrated module is implemented as a software functional module and sold or used as an independent product, it can also be stored in a computer-readable storage medium. This storage medium could be read-only memory, a disk, a CD, or other similar media.

The above description provides only exemplary embodiments of this application. However, the scope of protection of this application is not limited to these embodiments. Any modifications or alternatives that would be obvious to a person skilled in the art within the technical scope disclosed in this application should be considered within the scope of protection of this application. Therefore, the scope of protection of this application should be defined by the claims.

What is claimed is:

1. A method for processing recommendation data, comprising:
obtaining first definition information regarding a target scenario, wherein the first definition information is generated based on a knowledge graph related to the target scenario, the target scenario being a scenario involving at least one category of objects, and the first definition information comprises the least one category of objects;
obtaining second definition information about the target scenario based on the first definition information, wherein the second definition information comprises a combination of target categories including at least one target category from the at least one category;
generating recommendation data for an object corresponding to the combination of target categories based on the second definition information.

2. The method according to claim 1, further comprising:
obtaining first update information from the knowledge graph, generating a new scenario based on the first update information, and using the new scenario as the target scenario; or
obtaining second update information from the knowledge graph; updating an existing scenario based on the second update information to obtain an updated scenario; and using the updated scenario as the target scenario.

3. The method according to claim 1, wherein the at least one category comprises a plurality of categories and the obtaining of the second definition information about the target scenario based on the first definition information comprises:
determining the combination of target categories including the at least one target category from the plurality of categories, based on relationships between different categories of the plurality of categories;
generating the second definition information based on the combination of target categories.

4. The method according to claim 3, wherein the object is a product, and wherein the generating of recommendation data for the object corresponding to the combination of target categories based on the second definition information comprises:
determining a set number of target products corresponding to each target category of the combination of target categories;
forming a target product set by combining the set number of target products corresponding to each target category, and using the set as a target recommended product set for the combination of target categories;
adding the target recommended product set to candidate recommendation data corresponding to the combination of target categories;
generating the recommendation data based on the candidate recommendation data.

5. The method according to claim 4, wherein the generating of the recommendation data based on the candidate recommendation data comprises:
selecting a recommended product set to be recommended from the candidate recommendation data corresponding to the combination of target categories, wherein the candidate recommendation data comprises a plurality of recommended product sets, and the plurality of recommended product sets comprise the target recommended product set, with each recommended product set comprising at least one product;
generating the recommendation data based on the selected recommended product set.

6. The method according to claim 5, wherein the generating of the recommendation data based on the recommended product set to be recommended comprises:
determining a cover of the recommendation data based on the selected recommended product set;
using the cover as a presentation interface for the recommendation data;
generating a landing page to be displayed after the presentation interface is clicked, based on the products in the recommended product set, wherein the recommendation data comprises the presentation interface and the landing page.

7. The method according to claim 6, wherein the generating of the landing page to be displayed after the presentation interface is clicked based on the products in the recommended product set comprises:
obtaining a main product and an auxiliary product from the recommended product set, wherein the main product has a higher priority in a recommendation order than the auxiliary product;
determining display content for a display area corresponding to the recommended product set on the landing page based on the main product and auxiliary product;
generating the landing page based on the display content in the display area.

8. A recommendation method according to claim 1, further comprising:
receiving a data request from a client,
wherein generating recommendation data for an object corresponding to the combination of target categories based on the second definition information comprises:
generating recommendation data for an object corresponding to the combination of target categories based on the second definition information and the data request.

9. The method according to claim 8, further comprising:
determining filtered data based on the data request;
filtering the recommendation data based on the filtered data to obtain the filtered recommendation data;
sending the filtered recommendation data to a target module on a user application terminal of the client.

10. The method according to claim 9, wherein the target module on the user application terminal is used to process data related to a purchasing behavior of a user.

11. A recommendation data processing method for a client, comprising:
generating a recommendation data request based on a user's operation information;
sending the recommendation data request to a server;
receiving recommendation data sent by the server based on the recommendation data request, wherein the recommendation data is the recommendation data according to claim 9.

12. The method according to claim 11, wherein the generating of the recommendation data request based on the user's operation information comprises:
obtaining a record of the operation information;
determining a product the user has viewed based on the record;
adding the viewed product as filtered data to the recommendation data request.

13. The method according to claim 11, further comprising:
determining a combination to be processed within the recommendation data based on a user's first operation;
handling batch processing information for a product in the combination to be processed based on a user's second operation;
sending the batch processing information.

14. A recommendation data processing method for a client, comprising:
generating a recommendation data request based on a user's operation information;
sending the recommendation data request to a server;
receiving recommendation data sent by the server based on the recommendation data request, wherein the recommendation data is the recommendation data according to claim 1.

15. A non-transitory computer-readable storage medium configured with instructions executable by one or more processors to cause the one or more processors to perform operations comprising:
obtaining first definition information regarding a target scenario, wherein the first definition information is generated based on a knowledge graph related to the target scenario, the target scenario being a scenario involving at least one category of objects, and the first definition information comprises the least one category of objects;
obtaining second definition information about the target scenario based on the first definition information, wherein the second definition information comprises a combination of target categories including at least one target category from the at least one category;
generating recommendation data for an object corresponding to the combination of target categories based on the second definition information.

16. The non-transitory computer-readable storage medium according to claim 15, wherein the operations further comprising:
obtaining first update information from the knowledge graph, generating a new scenario based on the first update information, and using the new scenario as the target scenario; or
obtaining second update information from the knowledge graph; updating an existing scenario based on the second update information to obtain an updated scenario; and using the updated scenario as the target scenario.

17. The non-transitory computer-readable storage medium according to claim 15, wherein the at least one category comprises a plurality of categories and the obtaining of the second definition information about the target scenario based on the first definition information comprises:
determining the combination of target categories including the at least one target category from the plurality of categories, based on relationships between different categories of the plurality of categories;
generating the second definition information based on the combination of target categories.

18. The non-transitory computer-readable storage medium according to claim 17, wherein the object is a product, and wherein the generating of recommendation data for the object corresponding to the combination of target categories based on the second definition information comprises:
determining a set number of target products corresponding to each target category of the combination of target categories;
forming a target product set by combining the set number of target products corresponding to each target category, and using the set as a target recommended product set for the combination of target categories;
adding the target recommended product set to candidate recommendation data corresponding to the combination of target categories;
generating the recommendation data based on the candidate recommendation data.

19. The non-transitory computer-readable storage medium according to claim 18, wherein the generating of the recommendation data based on the candidate recommendation data comprises:
selecting a recommended product set to be recommended from the candidate recommendation data corresponding to the combination of target categories, wherein the candidate recommendation data comprises a plurality of recommended product sets, and the plurality of recommended product sets comprise the target recommended product set, with each recommended product set comprising at least one product;
generating the recommendation data based on the selected recommended product set.

20. An electronic device comprising:
one or more processors; and
one or more computer-readable memories coupled to the one or more processors and having instructions stored thereon that are executable by the one or more processors to perform operations comprising:
obtaining first definition information regarding a target scenario, wherein the first definition information is generated based on a knowledge graph related to the target scenario, the target scenario being a scenario involving at least one category of objects, and the first definition information comprises the least one category of objects;
obtaining second definition information about the target scenario based on the first definition information, wherein the second definition information comprises a combination of target categories including at least one target category from the at least one category; and
generating recommendation data for an object corresponding to the combination of target categories based on the second definition information.
